(19) United States
(12) Patent Application Publication
(10) Pub. No.: US 2006/0117979 A1
(43) Pub. Date: Jun. 8, 2006

(54) Apparatus and method for imaging a form cylinder of a printing unit

(76) Inventors: Josef Schneider, Diedorf (DE); Peer Dilling, Friedberg (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/267,533

(22) Filed: Nov. 4, 2005

(30) Foreign Application Priority Data
Nov. 6, 2004 (DE) 10 2004 053 739.9

(51) Int. Cl. B41F 33/00

(52) U.S. Cl. 101/483

(57) ABSTRACT

A printing unit having at least one press unit, the, or each, press unit having at least one form cylinder, a transfer cylinder, an inking unit and preferably a damping unit, and having at least one imaging device for imaging and/or de-imaging a rewritable and erasable printing form positioned on the form cylinder. The, or each, imaging device having at least one laser device for producing at least one laser beam and an optical device for focusing the, or each, laser beam on the printing form. At least the laser device of the, or each, imaging device is arranged at a distance from the respective form cylinder, it being possible for the, or each, laser beam produced by the laser device to be conducted via at least one optical fiber in the direction of the optical device of the imaging device positioned in the region of the respective form cylinder.

This application claims the priority of German Patent Document No. 10 2004 053 739.9, filed Nov. 6, 2004, the disclosure of which is expressly incorporated by reference herein.

### BACKGROUND AND SUMMARY OF THE INVENTION

The invention relates to a printing unit for a press.

Printing units of web-fed rotary presses, in particular of newspaper presses, have a plurality of press units, each press unit comprising a transfer cylinder, a form cylinder and an inking unit and damping unit. Press units and processes without a damping unit are also known. Furthermore, such printing units can have impression cylinders, it being possible for an impression cylinder to interact with one or more transfer cylinders of different press units. In addition to printing units which have such impression cylinders, printing units which have no impression cylinder are also known, the transfer cylinders of two press units rolling on each other in such printing units without impression cylinders. The transfer cylinders are also designated blanket cylinders, and the form cylinders are also designated plate cylinders. The form cylinders or plate cylinders bear printing forms.

When printing with a printing form, a distinction is in principle drawn between methods which, on the one hand, operate with a printing form which can be written once and, on the other hand, operate with a rewritable printing form. Printing methods which use rewritable printing forms are also summarized under the keyword “computer to press/direct imaging”. The present invention relates to a printing unit for a press which operates with rewritable printing forms. The applicant markets digital presses which operate with rewritable and erasable printing forms, under the product description “DICOweb”.

The principles of the DICOweb technology are described in “Handbuch der Printmedien [Handbook of print media], Helmut Kipphan, pages 674 to 680, year 2000, Springer-Verlag”. Printing units which operate with such rewritable and erasable printing forms have, in addition to the subassemblies described above, at least one imaging device for imaging and/or de-imaging the rewritable and erasable printing forms positioned on the form cylinders. Imaging devices for imaging and/or de-imaging the rewritable and erasable printing forms generally have a laser device for producing at least one laser beam, an optical device for focusing the, or each, laser beam onto the printing form, a feed device for imaging material, a feed device for conditioning medium and an erasing device for de-imaging the printing form. The imaging devices need a certain amount of installation space when the same are integrated into a printing unit.

Press units of web-fed rotary presses are increasingly being designed more compactly, that is to say with smaller dimensions. As a result, the overall room available on the printing units of a press is reduced, that is to say the space available for positioning and arranging the inking units, damping units and imaging devices. Furthermore, in the case of printing units having compact designs, access to the cylinders, specifically to the form cylinders and transfer cylinders, is made more difficult. In the case of printing units having small dimensions, the integration of imaging devices into the press while simultaneously ensuring simple access to the form cylinders and transfer cylinders of the printing units is already presenting considerable difficulties.

On this basis, the present invention is based on the problem of providing a novel type of printing unit for a press.

According to the invention, at least the laser device of the, or each, imaging device is arranged at a distance from the respective form cylinder and is therefore displaced out of the printing unit, it being possible for the, or each, laser beam produced by the laser device to be conducted via at least one optical fiber in the direction of the optical device of the imaging device positioned in the region of the respective form cylinder or integrated into the printing unit.

In the spirit of the present invention, it is provided to displace the laser device of the imaging device out of the imaging device, which is normally integrated into the printing unit of the press, and therefore out of the printing unit, and to introduce the, or each, laser beam produced by the laser device into the printing unit via at least one optical fiber. In this way, the overall space needed by the imaging devices in the printing unit can be reduced considerably, since the voluminous laser devices are no longer integrated into the printing unit but are instead displaced out of the printing unit. In the spirit of the present invention, only the subassemblies of the imaging device which have to be arranged or positioned in the region of the form cylinder for the purpose of imaging and/or de-imaging the printing form positioned on the form cylinder are integrated into the printing unit.

### BRIEF DESCRIPTION OF THE DRAWINGS

Preferred developments of the invention emerge from the following description. Exemplary embodiments of the invention will be explained in more detail by using the drawing, without being restricted thereto, where:

FIG. 1 shows a schematic plan view of a printing unit according to the invention.

### DETAILED DESCRIPTION OF THE DRAWINGS

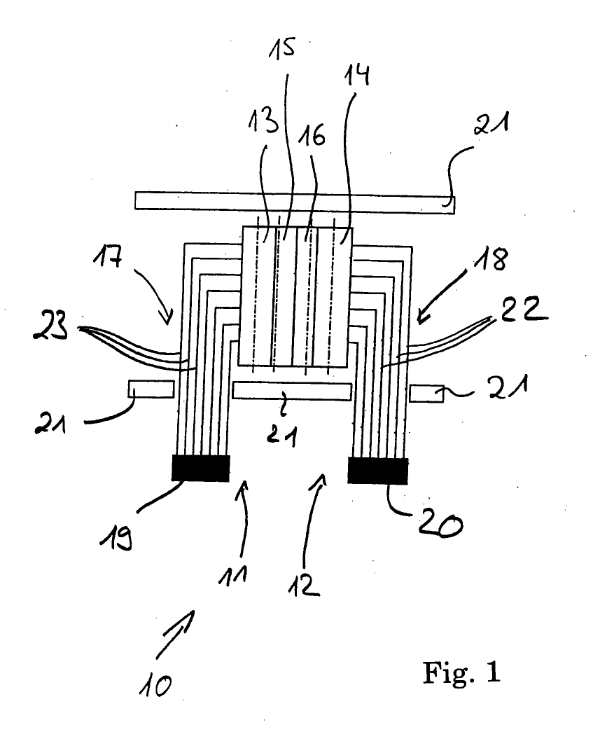

In the following, the present invention will be described in greater detail by reference to FIG. 1.

FIG. 1 shows a schematic plan view of a printing unit 10 according to the invention. Of the printing unit 10, two press units 11 and 12 are illustrated, each of the press units 11 and 12 comprising a form cylinder 13 and 14 and a transfer cylinder 15 and 16, respectively. In the exemplary embodiment illustrated, the transfer cylinders 15 and 16 of the two press units 11 and 12 roll on each other and in this way print a front side and a reverse side of a printing material, not illustrated. In the illustration of FIG. 1 the printing material is led between the two transfer cylinders 15 and 16 in such a way that the direction of movement of the printing material projects out of the plane of the drawing. The transfer cylinders 15 and 16 are also designated rubber-covered cylinders.

Positioned on the form cylinder 13 and 14 are printing forms, rewritable and erasable printing forms being used in the spirit of the present invention. Inking units, not illustrated, and damping units, not illustrated, interact with the form cylinders 13 and 14 in order to apply printing ink and a damping solution to the printing forms. In order to image and/or de-image the rewritable and erasable printing forms, each press unit 11 and 12 of the printing unit 10 is also assigned an imaging device 17 and 18, respectively. The imaging devices 17 and 18, which are used to image and/or de-image the printing forms positioned on the form cylinders 13 and 14, comprise a laser device for producing at least one laser beam, an optical device for focusing the, or each, laser beam on the printing form, a feed device for imaging material, a feed device for conditioning medium and an erasing device for de-imaging the printing form. The functioning of these individual subassemblies of the imaging devices 17 and 18 is familiar to those skilled in the art addressed here and therefore requires no more detailed explanation.

In the spirit of the present invention, it is provided to position at least the laser devices 19 and 20 of the imaging devices 17 and 18 at a distance from the respective form cylinder 13 and 14 and accordingly to displace them out of the printing unit 10. Thus, it can be gathered from FIG. 1 that the laser devices 19 and 20 of the imaging devices 17 and 18 are positioned on one side of the printing unit 10, outside the inner overall space of the printing unit 10 defined by a frame 21. In the spirit of the present invention, laser beams produced by the laser devices 19 and 20 are brought to the respective form cylinder 13 and 14 via optical fibers 22 and 23, specifically into the region of the optical devices integrated into the printing unit 10 and positioned in the region of the form cylinders 13 and 14 and with the aid of which the, or each, laser beam can be focused on the respective form cylinder.

Accordingly, it is in the spirit of the present invention to displace the subassemblies of the imaging devices 17 and 18 which do not have to be positioned immediately in the region of the form cylinders 13 and 14 out of the printing unit 10. In addition to the laser devices 19 and 20, these also include the control devices for the same. However, the subassemblies of the imaging devices 17 and 18 which have to be arranged or positioned in the vicinity of the form cylinders 13 and 14 in order to image and/or de-image the printing forms remain in the printing unit 10. These include the optical device already mentioned, the feed devices for conditioning medium and imaging material and also an erasing device for de-imaging the printing forms.

In the spirit of the present invention, the laser devices 19 and 20 and the control devices for the laser devices 19 and 20 are accordingly arranged outside the printing unit 10 and therefore outside an access region to the form cylinders 13 and 14. As a result, the form cylinders 13 and 14 remain easily accessible. The laser light produced by the laser devices 19 and 20 displaced out of the printing unit 10 is introduced into the printing unit 10 via the optical fibers 22 and 23 and fed to the optical devices in the region of the form cylinders 13 and 14. The optical fibers 22, 23 are preferably formed as glass fibers. Alternatively, the optical fibers can also be formed as plastic optical fibers, as they are known.

### LIST OF REFERENCE SYMBOLS

10 Printing unit
11 Press unit
12 Press unit
13 Form cylinder
14 Form cylinder
15 Transfer cylinder
16 Transfer cylinder
17 Imaging device
18 Imaging device
19 Laser device
20 Laser device
21 Frame
22 Optical fiber
23 Optical fiber

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit having a press unit, the press unit having a form cylinder, a transfer cylinder, an inking unit and a damping unit, and having an imaging device for imaging and/or de-imaging a rewritable and erasable printing form positioned on the form cylinder, the imaging device having a laser device for producing a laser beam and an optical device for focusing the laser beam on the printing form, wherein the laser device of the imaging device is arranged at a distance from the form cylinder and wherein the laser beam produced by the laser device is conducted via an optical fiber in a direction of the optical device of the imaging device positioned in a region of the form cylinder.

2. The printing unit according to claim 1, wherein the laser device of the imaging device, together with a control device for the laser device, are arranged at the distance from the form cylinder.

3. The printing unit according to claim 1, wherein the imaging device has a feed device for imaging material, a feed device for conditioning medium, an erasing device for de-imaging the printing form and a control device for activating the laser device.

4. The printing unit according to claim 3, wherein the optical device, the feed device for imaging material, the feed device for conditioning medium, and the erasing device for de-imaging the printing form of the imaging device are arranged in the region of the form cylinder and therefore integrated into the printing unit.

5. The printing unit according to claim 3, wherein the laser device, together with the control device for the laser device, are arranged at the distance from the form cylinder and are therefore displaced out of the printing unit.

6. The printing unit according to claim 1, wherein the optical fiber for conducting the laser beam produced by the laser device in the direction of the optical device is formed as a glass fiber.

7. An imaging apparatus for a form cylinder of a printing unit, where the form cylinder is disposed within a frame of the printing unit, comprising:
an imaging device including a laser device and an optical device, wherein the laser device is located outside of the frame of the printing unit and the optical device is located inside the frame and in a region of the form cylinder; and
an optical fiber disposed between the laser device and the optical device.

8. A method for imaging a printing form on a form cylinder of a printing unit, comprising the steps of:
producing a laser beam by a laser device, wherein the laser device is located outside of a frame of the printing unit;
conducting the laser beam from the laser device to an optical device through an optical fiber, wherein the optical device is located inside the frame and in a region of the form cylinder; and
focusing the laser beam on the printing form on the form cylinder by the optical device.
